(19) United States
(12) Patent Application Publication
(10) Pub. No.: US 2016/0272295 A1
(43) Pub. Date: Sep. 22, 2016

(54) CONNECTION SYSTEM, CONNECTION ARRANGEMENT AND METHOD

(71) Applicant: AIRBUS OPERATIONS GMBH, Hamburg (DE)

(72) Inventors: Hermann BENTHIEN, Hamburg (DE); Andreas POPPE, Hamburg (DE); Bastian SCHÄFER, Hamburg (DE)

(21) Appl. No.: 15/073,244

(22) Filed: Mar. 17, 2016

(30) Foreign Application Priority Data
Mar. 19, 2015 (DE) 10 2015 205 016.5

(51) Int. Cl. B64C 1/00; B32B 7/12; B64G 1/10; B32B 3/26

(52) U.S. Cl. CPC B64C 1/00; B32B 3/26; B32B 7/12; B64G 1/10; B32B 2605/18; B64C 2001/0081; B64C 2001/0072

(57) ABSTRACT

A connection system includes a first adhesion segment, on which a first planar bonding region is formed; a second adhesion segment, on which a second planar bonding region is formed, which is shaped so as to be complementary to the first planar bonding region, and a solidifiable, liquid bonding substance. The first planar bonding region and/or the second planar bonding region are each provided with receiving openings. The receiving openings extend like capillaries through each bonding region into the interior of each adhesion segment and, in order to form an integral bond between the first adhesion segment and the second adhesion segment, are designed such that the receiving openings receive the liquid bonding substance due to capillary ascension during application of the liquid bonding substance onto each bonding region.

### CROSS-REFERENCE TO RELATED APPLICATION

This application claims priority to German Patent Application DE 10 2015 205 016.5, filed Mar. 19, 2015, the entire disclosure of which is incorporated by reference herein.

### TECHNICAL FIELD

The present disclosure relates to a connection system, to a connection arrangement and to a method for integrally bonding structures. In particular, the present disclosure deals with the integral bonding of structures of an aircraft or spacecraft.

### BACKGROUND

Although the present disclosure and problem addressed thereby can be used in various applications for bonding highly diverse structures, they will be described in greater detail with respect to the mutual fastening of bearing aircraft structures.

A fuselage shell of a modern aircraft consists of a bearing frame structure made of stiff reinforcing elements which are covered by an outer skin. In addition to aluminum and aluminum alloys, reinforced fiber composite materials such as GLARE (glass laminate aluminum reinforced epoxy) or CFRP (carbon-fiber-reinforced polymer) are also used as material for the reinforcing elements and/or the outer skin. The bearing frame structure generally consists inter alia of formers which are oriented in the peripheral direction of the fuselage shell and longitudinally oriented stringers. A typical former is formed in turn of a plurality of curved former segments, which can be connected to one another, as well as to the stringers and the outer skin, by coupling elements.

DE 10 2008 040 577 A1 describes for example a coupling for connecting two former segments within a fuselage cell structure of an aircraft. In the document, for example FIG. 5 shows a connection of two former segments by two specific plates which are riveted to the former segments. An exemplary connection of this type must firstly meet multiple static requirements. Secondly, the typically very restrictive limitations on the total weight of the structure must simultaneously be adhered to. Furthermore, it is desirable for the assembly of the components to be as simple and time-saving as possible.

Conventional fastening elements such as metal rivets or screws do not only contribute to an increase in the weight of each structure. When using such elements, the assembly is also time-consuming and complex. For example, the holes required for the rivets and screws must be laboriously deburred. Furthermore, internal stresses resulting from cracks and cavities should be prevented by accordingly sealing them with solid or liquid materials.

By contrast, adhesively bonding components allows simplified assembly. In addition, by adhesive bonds, in many applications, weight can be saved by comparison with purely mechanical connections. However, conventional adhesive bonds are limited, since only relatively low adhesive forces act between the planar adhesive surfaces which are typically adhered in this case. Impurities in the adhesive used can also lower the maximum adhesion that can be achieved.

### SUMMARY

In view of the above, one idea of the present disclosure is to provide a lightweight adhesive bond which is particularly simple to assemble and which makes it possible fasten structures to one another in a stable and secure manner.

Accordingly, a connection system is provided. The connection system comprises a first adhesion segment, on which a first planar bonding region is formed. The connection system further comprises a second adhesion segment, on which a second planar bonding region is formed, which is shaped so as to be complementary to the first planar bonding region. Furthermore, the connection system comprises a solidifiable, liquid bonding substance. In this case, the first planar bonding region and/or the second planar bonding region are each provided with receiving openings. The receiving openings extend like capillaries through each bonding region into the interior of each adhesion segment. Furthermore, the receiving openings are designed to form an integral bond between the first adhesion segment and the second adhesion segment in such a way that, when the liquid bonding substance is applied to each bonding region, the receiving openings receive the liquid bonding substance.

Furthermore, a connection arrangement is provided. The connection arrangement comprises a first adhesion segment, on which a first planar bonding region is formed. The connection arrangement further comprises a second adhesion segment, on which a second planar bonding region is formed, which is shaped so as to be complementary to the first planar bonding region. In this case, the first planar bonding region and/or the second planar bonding region are each provided with receiving openings. The receiving openings extend like capillaries through each bonding region into the interior of each adhesion segment. Furthermore, the receiving openings are designed in such a way that the receiving openings receive a solidifiable, liquid bonding substance which is applied to each bonding region. Furthermore, the bonding regions are placed next to one another and are integrally bonded to one another by the bonding substance which is applied to the bonding regions.

Furthermore, a method is provided for integrally bonding a first adhesion segment to a second adhesion segment. The method includes the step of covering a first planar bonding region of the first adhesion segment and/or a second planar bonding region of the second adhesion segment, which region is designed so as to be complementary to the first planar bonding region, with a solidifiable, liquid bonding substance. The method further includes the step of placing the bonding regions next to one another. Furthermore, the method includes the step of wetting both bonding regions with the liquid bonding substance so that the liquid bonding substance itself is received by receiving openings which extend like capillaries through each bonding region into the interior of each adhesion segment. The method further includes the step of solidifying the liquid bonding substance.

One of the fundamental ideas of the present disclosure is to provide an adhesive bond between adhesion segments, in which the effective adhesion surface is increased many times over compared to conventional planar adhesion surfaces. In this case, an adhesion segment can be for example part of a structure of an aircraft or spacecraft, for example of a former segment. Here, the adhesion surface denotes the bonding surface via which two components are joined together by a bonding substance. For this purpose, the solution according to the disclosure herein provides specifically designed receiving openings which are formed through each bonding region into each adhesion segment. If two complementarily designed bonding regions covered with bonding substance are placed next to one another for assembly, then the receiving openings receive the bonding substance due to the capillary-like shape thereof. This increases the effective adhesion surface, because the total adhesion surface is formed as the sum of the contact surface of the two bonding regions and the inner surface, wetted with bonding substance, of the receiving openings. After the bonding regions are placed next to one another, the bonding substance must merely be solidified in order to create an integral bond between the two adhesion segments.

A particular advantage of the solution according to the disclosure herein is that, on the one hand, no expensive or heavy additional structures, such as screws, nuts, bolts, shims, etc. are required to fix two components to one another. Since the required holes, etc. are also omitted hereby, internal stresses are also automatically avoided to a certain extent, Furthermore, on the other hand, an adhesive bond is provided which, with the same contact surface, is significantly more loadable than for example adhesive bonds in which two planar, closed surfaces are bonded adhesively one on top of the other. The strength of an adhesive bond is determined in particular by the effective adhesion surface which, in the case of the present solution, is many times greater than in the case of a conventional planar surface adhesion (in this case, identical conditions are assumed for the join between bonding substance and component). Since mechanical fastening elements such as screws or rivets can either be completely omitted or at least are only required in small numbers in the solution according to the disclosure herein, depending on the application, the connection system according to the disclosure herein can be designed so as to be considerably ore weight efficient, which in turn saves fuel and costs. Furthermore, a connection system of this type can be assembled in a flexible, simple and rapid manner without expensive additional aids.

Another important advantage of the solution according to the disclosure herein arises with regard to possible impurities in the bonding substance, e.g. in the adhesive. In the case of the present solution, the effective adhesive surface can be increased, i.e. “spread into” the receiving openings, to such an extent that the adhesion between the bonding substance and the material of the adhesion segment or the bonding region is effectively no longer crucial, but rather it is the cohesion of the bonding substance per se that is decisive. However, impurities primarily have an adverse effect on the adhesion behavior of adhesives, whereas the cohesion behavior of the solidified adhesive is affected to a lesser extent in the present solution. The solution according to the disclosure herein thus provides a connection arrangement which is more robust with respect to impurities in the bonding substance.

Furthermore, the solution according to the disclosure herein opens up numerous possible designs of the receiving openings in the bonding regions or the adhesion segments, which provide additional advantages. For example, the adhesion segments can be designed in such a way that they reach the full rigidity thereof only after assembly in a connection arrangement according to the disclosure herein, i.e. in particular only after the bonding substance is received in the receiving openings. For example, the material of the adhesion segments can be selected in such a way, and/or a plurality of receiving openings can extend through the segments so densely, that the adhesion segments have a flexible structure prior to assembly, which is comparable for example to a sponge made of a flexible or soft material. During assembly, the bonding substance enters the capillary-like receiving openings and penetrates fully into the inside of the adhesion segments. The subsequent curing of the bonding substance solidifies the adhesion segments to a certain extent from the inside. As a result, very “soft” transitions can be produced in the connection arrangement of the adhesion segments. The adhesion segments advantageously cling to one another to a certain extent in the assembly due to the flexible design thereof. This hugely simplifies the assembly, since irregularities, notches, cracks, damage or any other assembly imperfections can easily be evened out. The curing of the bonding substance in this case initially provides a rigid connection arrangement of the adhesion segments next to one another.

Advantageous embodiments and developments can be found in the further dependent claims and in the description with reference to the figures.

For example, the receiving openings can be designed to form an integral bond between the first adhesion segment and the second adhesion segment in such a way that when the liquid bonding substance is applied to each bonding region, the openings receive the liquid bonding substance due to capillary ascension. The receiving openings are designed like capillaries so that when each bonding region is wetted with the liquid bonding substance, the substance rises into the receiving openings due to the adhesive forces acting between the bonding substance and the bonding region. This is known as capillary ascension and is a possible form of the physical capillary effect. Consequently, the inside surface of the receiving openings is wetted with bonding substance and the effective adhesion surface is increased by this portion. How high or deep the bonding substance rises into the receiving openings depends on various factors, such as the materials or substances used (for example density, viscosity, porosity, etc.) and on the shape of the capillaries, i.e. in particular on the diameter or the cross-sectional surface of the receiving openings. Depending on the desired effect and use, specific marginal conditions have to be met for the capillarity, and the materials have to be selected or possibly also pre-treated accordingly.

According to one development, the liquid bonding substance can be a lacquer and/or paint and/or adhesive and/or synthetic resin or the like. Accordingly, the method also provides solidifiable, liquid bonding substances which comprise lacquer and/or paint and/or adhesive and/or synthetic resin or the like. Thus, in particular not only can actual adhesives be used, but so can paints and lacquers.

For example, the bonding substance can be a lacquer which has been applied to adhesion segments of components of an aircraft. In this case, the respective bonding regions of the adhesion segments can be placed next to one another even during lacquering of the components, i.e. as long as the lacquer has not yet cured. The lacquer wets the respective bonding regions and enters the receiving openings. As soon as the lacquer has cured, the adhesion segments and thus the associated components are rigidly interconnected. Thus, here the lacquer acts in a sense as an adhesive so that, depending on the application, an additional adhesive may no longer be required. This also has the particular advantage, inter alia, that such bonds can be produced during lacquering and do not have to be produced only in the subsequent production. Therefore, for example, problems can be avoided which can traditionally arise during adhesion, which is usually carried out in a subsequent step.

Furthermore, the connection system according to the disclosure herein has the advantage that the receiving openings filled with the bonding substance automatically prevent the spread of cracks which may form for various reasons in the lacquer or also generally in a bonding substance after solidification. Cracks of this type are caused for example by defects which can be associated in the widest sense with the adhesion procedure (or with the lacquering procedure, etc.). For example, the bonding substance can become brittle due to aging processes, general material fatigue or external influences (for example the effects of heat or chemicals). The composition of the bonding substance can be suboptimal and/or incorrectly adapted to the materials of the components to be joined. In general, such cracks can also form as the result of permanently high stresses or acute overloading of the components. In particular, influences of this type are intensified when imperfections in an adhesive bond have occurred before or during assembly, for example due to an inadequate surface pre-treatment or to non-planar surfaces, air inclusions in the bonding substance or other general assembly faults.

Alternatively, components for an aircraft can firstly be lacquered and thereafter fixed to one another using an adhesive specifically applied for this purpose. For example, adhesion surfaces can be prepared accordingly on lacquered surfaces by laser ablation or similar processes. In principle, it is also possible here, for redundancy, for components to be attached to one another by a plurality of adhesion surfaces.

In the case of components made of carbon-fiber-reinforced plastics materials, a connection arrangement according to the disclosure herein can also already be produced in the production method of the components. For example, the components can be prepregs or the like, i.e. semi-finished products of carbon fibers which are embedded in an uncured matrix of synthetic resin. Prepregs of this type are typically used for the production of various components of modern aircraft or spacecraft. The prepregs are usually firstly introduced into the mould and then “baked through” in an autoclave, i.e. the plastics matrix is cured by subjecting to pressure and temperature. A connection arrangement according to the disclosure herein can for example interconnect two of such prepregs or can fix additional components thereto. In particular, adhesion segments according to the disclosure herein can be integrally bonded in such a way to structural components of an aircraft or spacecraft. In this case, the synthetic resin acts as a bonding substance which passes into the receiving openings.

Each bond is solidified in a subsequent autoclave process. In this case, the connection system is advantageously already provided during production of the structural components. Alternatively, at least the adhesion segments can already be integrally bonded to structural components in production. The adhesion segments according to the present disclosure can also be integrally bonded on this basis only in a later separate step.

Accordingly, a development of the method also provides synthetic resin as the solidifiable, liquid bonding substance. In this development, the solidification step can comprise curing using an autoclave, For example, the method further comprises the step of fixing the adhesion segments to one another by at least one fixing needle. In this development, the adhesion segments can be fixed to one another or for example to prepregs before the components are cured in an autoclave. Furthermore, in a development the method also comprises the step of covering the connection system with a film. In addition, the method can further comprise the step of evacuating the covered connection system through at least some of the receiving openings. Before the components are subjected to pressure and temperature in the autoclave process, the connection system is covered by a film and evacuated. Evacuation can advantageously be carried out via the openings in the adhesion segments.

According to a development, some portions of or all of the bonding regions can be planar or substantially planar. For many applications, a predominantly planar bonding region is advantageous, for example because adhesion segments comprising bonding regions of this type are easy to produce.

According to a development, the receiving openings extend substantially vertically from each bonding region into the interior of each adhesion segment. In this development, the receiving openings are designed in such a way that they can be used as simply and in as versatile a manner as possible, but at the same time they afford the capillary-like form required for utilising the capillary effect.

For example, the adhesion segments consist substantially of plastics material. The use of plastics material has the great advantage that weight and costs can be reduced.

Furthermore, the adhesion segments can be formed in one piece. Combined with the previous development, the adhesion segments can be produced for example by an additive-layer manufacturing method (3D printing) or the like. This has the advantage that complex designs can also be easily produced.

According to a development, the first planar bonding region and/or the second planar bonding region is formed with projecting spacer pins. Spacer pins of this type make it possible, when placing the bonding regions covered with bonding substance next to each other, to precisely set a desired thickness of the bonding layer, for example the thickness of a lacquer or adhesive layer, so that optimum bonding properties can be ensured, Alternatively, pins of this type can also be used to define separate bonding regions so that adhesion segments can be fastened to one another via a plurality of surfaces. For example, the first bonding region can have a circular surface which is provided with three protruding spacer pins having the same shape. The second bonding region, however, can be designed so as to be completely planar, without protruding pins. If the two bonding regions are then placed next to one another in order to produce the connection arrangement, after they have been covered with bonding substance, then the spacer pins define a predefined bond thickness and thus also the ensuing bond strength.

According to a development, the first planar bonding region and/or the second planar bonding region is formed with at least one projecting fixing pin. A fixing pin of this type is used for example to fix the adhesion segments in specific positions to one another or to structures. Thus, a hole or another depression, acting as a marking, into which the fixing pin can be introduced during the production of the connection arrangement can be provided in the surface of the structure or of an adhesion segment. In this development, the adhesion segments can be attached particularly easily in an intended position relative to one another or to a structure.

For example, at least some of the receiving openings extend through the first adhesion segment and/or the second adhesion segment. This advantageously provides access to the adhesion or bonding points. For example, this can be used for evacuation in the case of fixing to a prepreg in the autoclave process.

The embodiments and developments above can be combined with one another as desired where appropriate. Further possible embodiments, developments and implementations of the disclosure herein also do not comprise explicitly mentioned combinations of features of the disclosure herein described previously or in the following with respect to the embodiments. In particular, in the process a person skilled in the art will also add individual aspects as improvements or additions to the respective basic form of the present disclosure.

### BRIEF DESCRIPTION OF THE DRAWINGS

The present disclosure will be described in greater detail below on the basis of the embodiments shown in the schematic drawings, in which:

FIG. 1a is a schematic cross-sectional view of an adhesion segment of a connection system according to the disclosure herein, according to one embodiment of the disclosure herein;

FIG. 1b is a schematic cross-sectional view of two embodiments of he adhesion segment from FIG. 1a;

FIG. 1c is a schematic cross-sectional view of a connection arrangement according to the disclosure herein comprising the connection system from FIG. 1b;

FIG. 2a is a schematic cross-sectional view of connection arrangements according to another embodiment of the disclosure herein;

FIG. 2b is a schematic detailed view of one of the connection arrangements from FIG. 2a;

FIG. 3 is a schematic cross-sectional view of an adhesion segment of a connection system according to the disclosure herein after assembly according to another embodiment of the disclosure herein; and

FIG. 4 is a schematic flow chart of a method according to the disclosure herein for assembling a connection arrangement according to the disclosure herein.

The accompanying figures are intended to provide further understanding of the embodiments of the disclosure herein. They illustrate embodiments and are used, in conjunction with the description, to explain principles and concepts of the disclosure herein. Other embodiments and many of the above-mentioned advantages emerge from the drawings. The elements of the drawings are not necessarily shown to scale with respect to one another.

In the figures of the drawings, elements, features and components which are like, functionally like or have the same effect—unless otherwise specified—are each provided with the same reference numerals.

### DETAILED DESCRIPTION

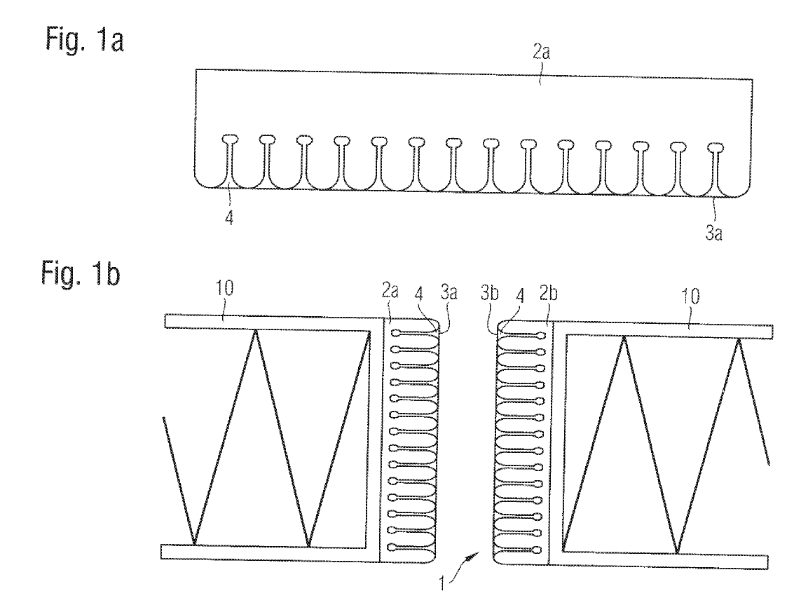

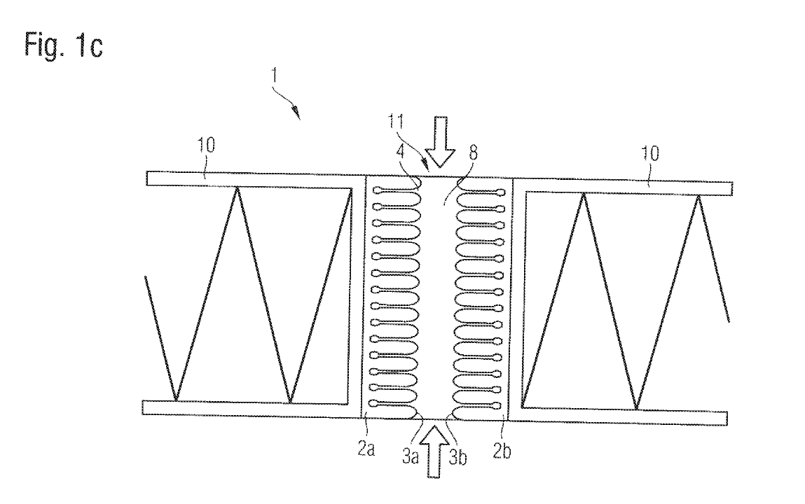

FIG. 1a is a schematic cross-sectional view of an adhesion segment of a connection system according to the disclosure herein, according to one embodiment of the disclosure herein.

In FIG. 1a, the reference numeral 2a denotes the adhesion segment of the connection system 1. The connection system 1 is designed to mutually fasten a plurality of adhesion segments 2a of this type. An adhesion segment 2a of this type can be for example part of a component or a structure 10 of an aircraft or spacecraft (not shown here). Alternatively, an adhesion segment 2a of this type can also be a separate component, which is connected for example to a structure 10. Such a structure can be for example a former, a former segment, a stringer or the like or a coupling element for connecting a plurality of such or similar components.

For example, the described adhesive segment 2a is used when connecting former segments if other fastening options such as holes or screw and riveted connections are not permitted or desired. In principle, all the embodiments of the connection system 1 according to the disclosure herein described in the following can be used with suitable adaptations for any other aircraft or spacecraft, other vehicles and for further different areas of use.

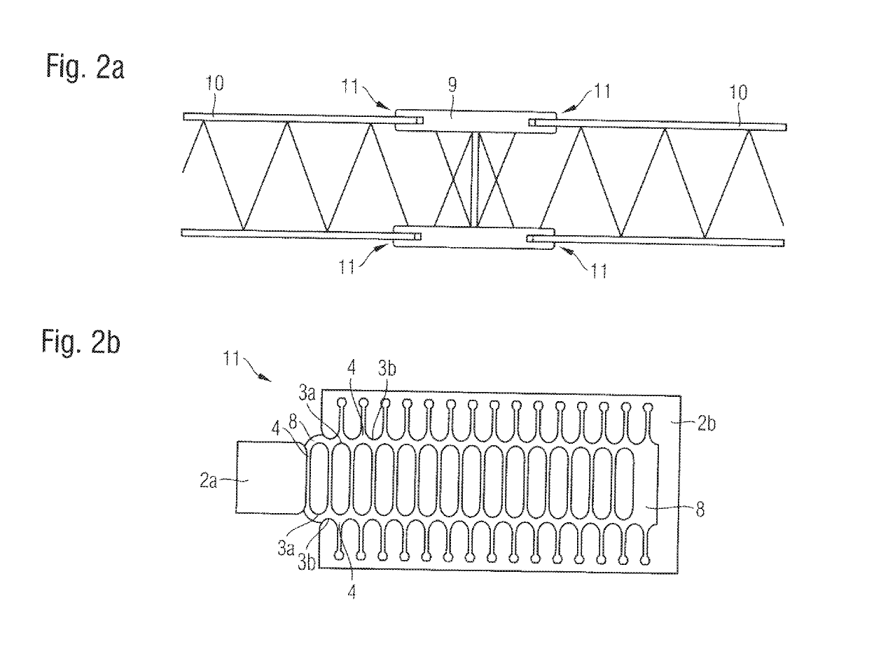

The adhesion segment 2a comprises a planar bonding region 3a which is designed so as to be substantially flat. On the adhesion segment 2a, the bonding region 3a is provided with a plurality of receiving openings 4 which extend like capillaries through the bonding region 3a into the interior of the adhesion segment 2a. The adhesion segment 2a can be for example a cuboid-like component, and the bonding region 3a can accordingly be designed as a rectangular planar surface. Alternatively, the adhesion segment 2a can for example also be cylindrical, and the bonding region 3a can be designed as a circular surface. In principle, however, any desired other geometric designs and relatively complex shapes of the adhesion segment 2a and the bonding region 3a are also provided. The receiving openings 4 are distributed uniformly over the bonding region 3a. In this embodiment, the adhesion segment 2a comprises precisely one planar bonding region 3a. Furthermore, however, embodiments having bonding regions 3a are also provided which are composed of a plurality of planar portions (one example is shown in FIG. 2b). The adhesion segment 2a comprises or consists of plastics material and has been produced for example as a single-piece component by an additive-layer manufacturing method (3D printing) or the like. Three-dimensional printing methods of this type can be used in a very flexible manner to also produce complex plastics articles. For example, in the embodiment shown in FIG. 1a, the receiving openings 4 extend substantially vertically from the bonding region 3a into the interior of the adhesion segment 2a. However, in 3D printing, other arrangements can also be realized at no great expense.

The receiving openings 4 are designed to form an integral bond between the adhesion segment 2a and another adhesion segment. For this purpose, the bonding region 3a is covered with a solidifiable, liquid bonding substance 8. Adhesives, lacquers, paints and synthetic resins, inter alia, are provided as the bonding substance, In the following embodiments, for example a synthetic resin is used. However in principle, any other bonding substance can be used which can produce an integral bond between adhesion segments 2a of this type.

FIG. 1a shows the adhesion segment 2a prior to assembly. The receiving openings 4 are designed in such a way that they receive a bonding substance 8 which is applied to the bonding region 3a and wets the region. In this case, the bonding substance 8 is received in the receiving openings 4 due to what is known as capillary ascension. This is a possible form of the physical capillary effect which occurs due to the interaction of a liquid with a capillary-like constriction, for example with a thin pipe, a gap or another cavity. Here, there is an interaction between the adhesive forces of the corresponding liquid and the cohesive forces of the liquid with the solid wall material of the capillaries. Capillary ascension occurs when the corresponding liquid wets the material of the capillaries. In this case, the liquid rises in the capillaries and forms a concave surface which is at a higher level than the liquid in the surroundings of the capillaries (for example when a small thin pipe is immersed into a container filled with liquid). The specific behavior of the liquid, for example the rising height of the liquid inside the capillaries depends on various factors. Thus, the material of the capillary and also of the liquid is critical, for example the density or viscosity of the liquid or the porosity of the capillaries. Furthermore, the arrangement and shape of the capillaries is relevant, for example the cross-sectional area of the capillaries. In the case of a substantially circular cylindrical capillary, the diameter size is particularly significant and has to be optimised accordingly subject to liquid and capillary material.

FIG. 1b is a schematic cross-sectional view of two embodiments of the adhesion segment 2a, 2b from FIG. 1a; The two adhesion segments 2a, 2b have identical designs and both are respective components of respective structures 10 of an aircraft or spacecraft, for example a former segment. In one embodiment by way of example, the structure can be what is known as a prepreg, i.e. a semi-finished product of carbon fibers which are embedded in an uncured matrix of synthetic resin. For example in a subsequent production step, the prepreg can be baked through in an autoclave to form a former or a former segment of an aircraft, i.e. it can be cured by being subjected to pressure and temperature. In this case, the adhesion segments 2a, 2b can comprise or consist of plastics material and can be bonded to each prepreg by a layer of synthetic resin. The bond between the adhesion segments 2a, 2b and each prepreg is then solidified in the subsequent autoclave process. Depending on the design of the adhesion segments 2a, 2b, the segments themselves also retain the full rigidity or hardness thereof in this case, only as a result of the fact that the solidified bonding substance 8 solidifies the segments to a certain extent from the inside. For example, receiving openings can extend through the adhesion segments 2a, 2b so densely, and/or the material of the adhesion segments 2a, 2b can be selected in such a way that, prior to curing the bonding substance 8, i.e. for example the resin, the segments have a flexible and/or soft structure and retain the full rigidity thereof only as a result of the cured bonding substance 8.

FIG. 1c is a schematic cross-sectional view of a connection arrangement 11 according to the disclosure herein comprising the connection system I from FIG. 1b. In FIG. 1b, the adhesion segments 2a, 2b are still located at a distance from one another. In FIG. 1c, the respective bonding regions 3a, 3b of the adhesion segments 2a, 2b have been placed next to one another, after the liquid bonding substance 8 has been introduced between the two bonding regions 3a, 3b (indicated by the two arrows). In FIG. 1c, the bonding substance 8, for example a synthetic resin, has already risen up into the receiving openings 4. The bonding substance 8 wets each bonding region 3a, 3b and, as a result of the adhesive forces acting between the bonding substance 8 and each adhesion segment 2a, 2b, rises into the receiving openings 4. Consequently, the inside surface of the receiving openings 4 is also wetted with bonding substance 8, and the effective adhesion surface, i.e. the bonding surface by which the adhesion segments 2a, 2b are joined together by the bonding substance 8, increases accordingly by this amount, multiplied by the number of receiving openings 4. The effective adhesion surface can be maximized due to the shape and arrangement of the receiving openings 4 inside the adhesion segments 2a, 2b.

In order to bond the two adhesion segments 2a, 2b, the bonding substance 8 must be solidified at least in the region of the two bonding regions 3a, 3b only by appropriate methods (in this case of synthetic resin, this takes place for example in an autoclave). An integral bond is thus formed between the two adhesion segments 2a, 2b, i.e. between the two structures 10. If a synthetic resin, a lacquer or a paint is used, then these are used to a certain extent as an adhesive between the two adhesion segments 2a, 2b.

The adhesion segments 2a, 2b shown in FIGS. 1a, 1b and 1c have an effective adhesion surface which is several times greater than that of conventional planar adhesion surfaces, for example an adhesion surface corresponding to the bonding regions 3a, 3b shown in FIGS. 1a, 1b and 1c. This makes it possible to use not only conventional adhesives for fixing adhesion segments 2a, 2b of this type, but also synthetic resins, lacquers or paints. In general, the adhesive bond which is produced with the same support surface is significantly more loadable than in the case of conventional adhesive bonds, in which two planar surfaces are adhesively bonded one on top of the other. The connection system 1 according to the disclosure herein can thereby be designed to be significantly more weight efficient, which in turn saves fuel and reduces costs, particularly also compared to purely mechanical connections using screws and rivets. Furthermore, a connection system 1 of this type can be assembled in a flexible, simple and rapid manner without expensive additional aids, In particular, the connection system 1 in this case can still be used during the production of structures 10, for example prior to an autoclave process, to connect the structures 10 as long as the synthetic resin has not yet been cured.

Differently sized designs of the connection system 1 are provided, from a few millimetres to many centimetres or even metres. Both the size of the adhesion segments 2a, 2b and that of the receiving openings 4 can be selected according to the area of use of the connection system 1. Accordingly, the specific size of the receiving openings 4 is also variable.

FIG. 2a is a schematic cross-sectional view of connection arrangements 11 according to another embodiment of the disclosure herein.

In the drawing, two structures 10 of an aircraft, for example two former segments, are interconnected by a coupling element 9. The coupling element 9 is connected to each of the structures 10 in each case by two connection arrangements 11 according to the present disclosure.

FIG. 2b is a schematic detailed view of one of the connection arrangements 11 from FIG. 2a;

In principle, the connection arrangement 11 in FIG. 2b is constructed similarly to that in FIG. 1c, In this case as well, respective bonding regions 3a, 3b of two adhesion segments 2a, 2b are placed next to one another. A bonding substance 8 has been introduced between the two bonding regions 3a, 3b in such a way that the bonding regions 3a, 3b have been wetted by the bonding substance 8. Similarly to in the embodiment in FIG. 1c, the bonding regions 3a, 3b are provided with a plurality of receiving openings 4 which extend like capillaries through each bonding region 3a, 3b into the interior of each adhesion segment 2a, 2b. In this case as well, the receiving openings 4 are designed in such a way that the liquid bonding substance 8 rises up into the receiving openings due to capillary ascension.

By contrast with the embodiment in FIG. 1c, the first adhesion segment 2a is shaped like a bolt, wherein an upper part of the bolt is connected to the lower part of the bolt via the receiving openings. Accordingly, the first adhesion segment 2b including the associated bonding region 3b is designed as a receiving opening for the bolt so as to be complementary to the adhesion segment 2a. Both bonding regions 3a, 3b thus each comprise or consist of a plurality of planar portions.

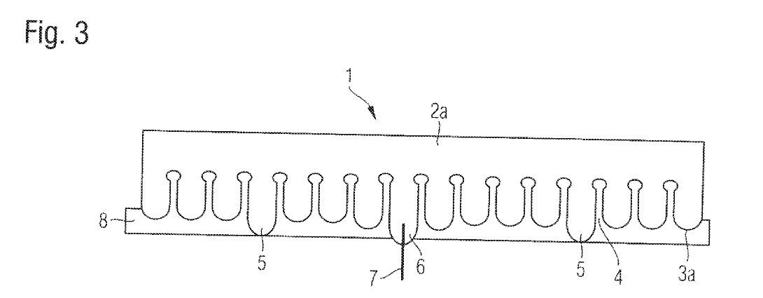

FIG. 3 is a schematic cross-sectional view of an adhesion segment 2a of a connection system 1 according to the disclosure herein after assembly according to another embodiment of the disclosure herein.

The basic construction of the adhesion segment 2a shown in FIG. 3 and the assembly thereof correspond substantially to those of the adhesion segment 2a from FIG. 1a. However, the adhesion segment 2a in FIG. 3 is additionally provided with a fixing pin 6 in the center of the bonding region 3a, which pin projects from the bonding region 3a. The fixing pin 6 is used to fix the adhesion segment 2a in a specific position. The target position can be provided for example using a marker or another marking, which can be for example a hole or another depression in the surface of a structure 10 or another adhesion segment 2b. The fixing pin or pins 6 can thus be easily fixed in the desired position while the adhesion segment 2a is being assembled, by introducing the fixing pins 6 of the adhesion segment 1 into the corresponding marker. Furthermore, the adhesion segment 2a can be fixed by fixing needles 7 or the like, for example to the fixing pins 6 (e.g. in the case where the bonding substance 8 is a synthetic resin, and the connection arrangement is cured by an autoclave).

The adhesion segment 2a shown in FIG. 3 also comprises a plurality of projecting spacer pins 5 on the bonding region 3a. The spacer pins 5 make it possible, when placing the adhesion segment 2a next to another adhesion segment 2b, to precisely set the thickness of the bonding layer made of bonding substance so that optimum adhesion properties can be ensured. The thickness of the bonding layer is defined by the distance by which the spacer pins 5 project beyond the bonding region 3a. For example, at least three spacer pins 5 of this type can be provided, which are not arranged on a line. Alternatively, such spacer pins 5 can also be used to define separate bonding regions so that an adhesion segment 2a can be fixed over a plurality of surfaces. The use of spacer pins 5 further simplifies the assembly of such adhesion segments 2a. The fixing pins 6 allow a convenient adjustment of the position of the adhesion segment 2a, while the spacer pins 5 ensure an optimum orientation of the adhesion segment 1 in the adjusted position and an optimum adhesive layer.

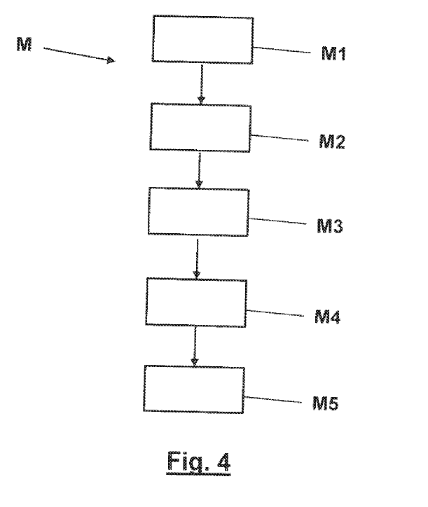

FIG. 4 is a schematic flow chart of a method M according to the disclosure herein for assembling connection arrangements 11 according to the disclosure herein, as shown for example in the previous figures.

The method M for integrally bonding a first adhesion segment 2a to a second adhesion segment 2b includes the step M1 of covering a first planar bonding region 3a of the first adhesion segment 2a and/or a second planar bonding region 3b of the second adhesion segment 2b, which region is designed so as to be complementary to the first planar bonding region 3a, with a solidifiable, liquid bonding substance 8. The method M further includes the step M2 of placing the bonding regions 3a, 3b next to one another. Furthermore, the method M includes the step M3 of wetting both bonding regions 3a, 3b with the liquid bonding substance so that the liquid bonding substance 8 itself is received by receiving openings 4 which extend like capillaries through each bonding region 3a, 3b into the interior of each adhesion segment 2a, 3b. Optionally, the method M comprises the step M4 of fixing M4 the adhesion segments 2a, 2b to one another by at least one fixing needle 7. The method further includes the step M5 of solidifying the liquid bonding substance 8. When the liquid bonding substance 8 is a synthetic resin 8, the solidifying step M5 includes curing the bonding substance 8 using an autoclave.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A connection system, comprising:
a first adhesion segment, on which a first planar bonding region is formed;
a second adhesion segment, on which a second planar bonding region is formed, which is shaped so as to be complementary to the first planar bonding region; and
a solidifiable, liquid bonding substance;
wherein the first planar bonding region and/or the second planar bonding region are each provided with receiving openings which extend like capillaries through each bonding region into the interior of each adhesion segment and, in order to form an integral bond of the first adhesion segment to the second adhesion segment, are designed such that the receiving openings receive the liquid bonding substance during application of the liquid bonding substance onto each bonding region.

2. The connection system according to claim 1, wherein the receiving openings are designed to form an integral bond of the first adhesion segment to the second adhesion segment such that when the liquid bonding substance is applied to each bonding region, the openings receive the liquid bonding substance due to capillary ascension.

3. The connection system according to claim 1, wherein the liquid bonding substance is a lacquer and/or paint and/or adhesive and/or synthetic resin.

4. The connection system according to claim 1, wherein some portions of or all of the bonding regions are planar.

5. The connection system according to claim 1, wherein the receiving openings extend substantially vertically from each bonding region into the interior of each adhesion segment.

6. The connection system according to claim 1, wherein the adhesion segments comprise substantially of plastics material.

7. The connection system according to claim 1, wherein the adhesion segments are formed in one piece.

8. The connection system according to claim 1, wherein the first planar bonding region and/or the second planar bonding region is formed with projecting spacer pins.

9. The connection system according to claim 1, wherein the first bonding region and/or the second bonding region is formed with at least one projecting fixing pin.

10. The connection system according to claim 1, wherein at least some of the receiving openings extend through the first adhesion segment and/or the second adhesion segment.

11. A connection arrangement, comprising:
a first adhesion segment, on which a first planar bonding region is formed; and
a second adhesion segment, on which a second planar bonding region is formed, which is shaped so as to be complementary to the first planar bonding region,
wherein the first planar bonding region and/or the second planar bonding region are each provided with receiving openings which extend like capillaries through each bonding region into the interior of each adhesion segment and are designed in such a way that the receiving openings receive a solidifiable, liquid bonding substance which is applied to each bonding region; and wherein the bonding regions are placed next to one another and are integrally bonded by the bonding substance which is applied to the bonding regions.

12. An aircraft or spacecraft including a connection arrangement comprising:
a first adhesion segment, on which a first planar bonding region is formed; and
a second adhesion segment, on which a second planar bonding region is formed, which is shaped so as to be complementary to the first planar bonding region,
wherein the first planar bonding region and/or the second planar bonding region are each provided with receiving openings which extend like capillaries through each bonding region into the interior of each adhesion segment and are designed such that the receiving openings receive a solidifiable, liquid bonding substance which is applied to each bonding region; and wherein the bonding regions are placed next to one another and are integrally bonded by the bonding substance which is applied to the bonding regions.

13. A method for the integral bonding of a first adhesion segment to a second adhesion segment, the method comprising:
covering a first planar bonding region of the first adhesion segment and/or a second planar bonding region of the second adhesion segment, which region is designed so as to be complementary to the first planar bonding region, with a solidifiable, liquid bonding substance;
placing the bonding regions next to one another;
wetting both bonding regions with the liquid bonding substance so that the liquid bonding substance itself is received by receiving openings which extend like capillaries through each bonding region into the interior of each adhesion segment; and
solidifying the liquid bonding substance.

14. The method according to claim 13, wherein the liquid bonding substance is a synthetic resin and the solidification step comprises curing using an autoclave.

15. The method according to claim 14, further having the method step of fixing the adhesion segments to one another by at least one fixing needle.
